(19) United States
(12) Patent Application Publication
(10) Pub. No.: US 2004/0013806 A1
(43) Pub. Date: Jan. 22, 2004

(54) Coating method and coating apparatus

(76) Inventors: Timo Kiiha, Menasha (FI); Jukka Koskinen, Jarvenpaa (FI)

Correspondence Address: Michael C Stuart, Cohen Pontani Lieberman & Pavane, Suite 1210, 551 Fifth Avenue, New York, NY, 10176, US

(21) Appl. No.: 10/399,001

(22) PCT Filed: Oct. 9, 2001
(86) PCT No.: PCT/FI01/00876

(30) Foreign Application Priority Data
Oct. 13, 2000 (FI) 20002275

(51) Int. Cl. B05D 3/12

(52) U.S. Cl. 427/355; 118/118; 118/123

(57) ABSTRACT

The present invention relates to a method for coating a web (2) of paper or paper board moving supported by a backing roll (1) or for coating a roll of a film-transfer press, the method comprising the steps of doctoring the surface of the web (2) or the roll of the film-transfer press, and applying the coating mix to the surface of the web (2) or the roll of the film-transfer press. A cooling fluid is applied to the meeting point of the surface (2) to be doctored and the doctoring element (3) prior to the start of coating mix application.

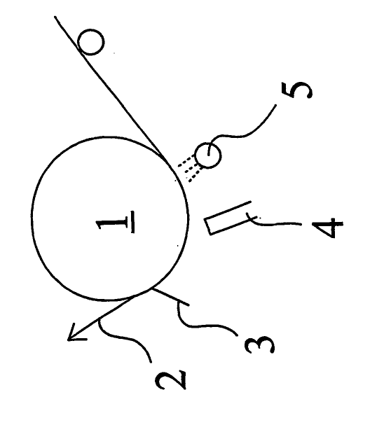

The present invention relates to a coating method according to the preamble of claim 1. The invention also relates to a coater suited for implementing the method.

In the coating of paper and paperboard webs, to the surface of a moving web of paper is applied a layer of a coating mix, whereupon the excess coat is doctored away and the surface of the applied coating layer is smoothed generally using a doctor blade or a reverse rotating smoothing roll. Finally, the excess water embedded in the coating layer is removed by dryers.

Prior to doctoring, the coat weight on the web surface is typically 200 to 300 g/m², while after doctoring the coat weight is typically 5 to 20 g/m². As the drying capacity of dryer units is generally designed to cope with the coat weight after doctoring, all the excess coating must be doctored away from the web surface before drying the coated web to avoid soiling of papermaking units located downstream from the dryer units. Hence, at the coater run up, the doctor element is set to doctor the web to be coated already before the application of the coating mix is commenced. Hereby, the doctor blade heats up when running on the surface of the uncoated base web. Next, when the application of the coating mix is initiated, the coating mix dries hard on the hot doctor blade, thus deteriorating the quality of the applied coat. Moreover, it may take a long time before the coating adhered to the doctor blade falls off. Typically, the doctor blade runs uncooled for 1 to 2 seconds on the base web surface, before the application of the coating mix begins. During this time, the temperature of the doctor blade tip may rise as high as 1000° C., whereby violent warping of the tip takes place. Similar heating problems can also occur in coaters equipped with a reverse smoothing roll.

Attempts have been made to reduce the heating tendency of the doctor element at the beginning of the coating mix application by way of speeding up the start sequence of coating application. Nevertheless, due to the slowness of mechanical movements, limited operating speed of valves and pumping in the coating mix circulation as well as delays in the automation system, the starting sequence takes too long a time, particularly in applicators and on-machine coaters running at high speeds above 1500 m/min, wherein coating must be commenced at full web speed.

It is an object of the present invention to provide a novel type of coating method and coater capable of overcoming the above-described problems.

The goal of the invention is achieved by virtue of applying a cooling fluid, such as water, to the contact point between the surface to be doctored and the doctor element, whereby the fluid serves to cool and lubricate the doctor blade or smoothing roll of the coater before the application of the coating mix is commenced.

More specifically, the coating method according to the invention is characterized by what is stated in the characterizing part of claim 1.

Furthermore, the coater according to the invention is characterized by what is stated in the characterizing part of claim 5.

The invention offers significant benefits.

By virtue of cooling, heating of the doctor element is prevented, whereby drying of the coating mix onto the doctor blade or smoothing roll is avoided. Also such problems as hardening and warping of the doctor element are eliminated. Because the required amount of cooling fluid is relatively small, the strength qualities of the web are not compromised essentially. Moreover, the cooling system is simple to construct and can be readily retrofitted in existing coaters.

In the following, the invention will be examined in more detail by making reference to the appended drawing, wherein is shown a coater according to the invention in a cross-sectional view.

Referring to the drawing, the coater shown therein is advantageously an on-machine coater designed for high web speeds in the order of 1500-2000 m/min and/or suited for cooperation with other papermaking machinery. Supported by a backing roll 1, a web 2 is adapted to run through the coater. The travel direction of the web 2 is denoted by an arrow. Coating mix is applied to the surface of the web 2 from an applicator apparatus 4, such as a jet nozzle extending over the cross-machine width of the web 2 or an applicator chamber of the short-dwell type. A doctor blade 3 is used for removing excess coating from the web surface and leveling the surface of the applied coat. Alternatively, a smoothing roll can be employed as the doctor element in lieu of the doctor blade 3.

When the coating is started, the doctor element 3 is first moved to doctor along the surface of the web 2. At this stage, the coating mix flow from the applicator apparatus 4 is not yet turned on. Generally simultaneously with the instant the doctor blade 3 meets the surface of the web 2, cooling means 5 begin to spray to the surface of the web 2 a cooling fluid, advantageously water. Herein, for instance a liquid jet nozzle 5 extending over the cross-machine width of the web 2 may be used as the cooling means. The cooling fluid is applied to the web 2 in a close vicinity of the doctor blade 3, whereby at least a portion of the cooling fluid travels to the meeting point between the web 2 and the doctor blade 3 thus cooling the doctor blade 3 heated by friction. The spraying rate of cooling fluid is controlled so that the strength qualities of the web 2 are not essentially compromised. Furthermore, the web 2 may not be wetted so much that it begins to adhere to the backing roll 1 or other rolls downstream from the coater. When water is used as the cooling liquid, the amount of sprayed fluid is typically in the order of 1-20 g/m², advantageously 4-8 g/m². In the embodiment illustrated in the diagram, the liquid jet nozzle 5 is located in front of the applicator apparatus 4 in the web travel direction, but it may alternatively be situated between the applicator apparatus 4 and the doctor element 3. Advantageously, the spraying point of the cooling fluid is located relatively close to the doctor element 3, whereby no essential absorption of the cooling fluid into the web 2 can take place before the meeting point of the web 2 and the doctor blade 3.

As soon as the application of the coating mix from the applicator apparatus 4 is commenced, the spraying of the cooling fluid onto the web 2 is cut off. Typically, the spraying of the cooling fluid at coater runup must be carried out for at least 1 to 2 seconds, which is the time from the start of doctoring of web 2 to the start of application. If necessary, the spraying of the cooling fluid may be initiated already before doctoring begins.

In addition to those described above, the invention may have alternative embodiments. For instance, the liquid jet nozzle 5 can be located to operate in conjunction with the doctor element 3, whereby the jet nozzle injects the cooling fluid directly to the meeting point of the doctor blade or smoothing roll and the web being doctored. In lieu of water, also other flowable substances may be used as the cooling fluid, such as air, steam, small amounts of coating mix or a size used in surface-sizing of paper.

The arrangement according to the invention may also be used in a film-transfer press comprised of two rolls defining a nip through which the web being coated is passed. Herein, a film layer of desired coating mix or size is first applied to the surface of a roll or rolls, whereupon the film is smoothed by a reverse smoothing roll or doctor blade. Finally, the film of coating mix or size thus formed on the surface of a roll or rolls is transferred to the web in the nip defined by the rolls. At the run up of such a film-transfer press, the doctor element doctoring a roll surface can be cooled before the application of the coating mix to the roll surface is initiated.

1. A method for coating a web (2) of paper or paperboard moving supported by a backing roll (1) or for coating a roll of a film-transfer press, the method comprising the steps of
doctoring the surface of said web (2) or said roll of said film-transfer press, and
applying the coating mix to the surface of said web (2) or said roll of said film-transfer press,
characterized in that
a cooling fluid is applied to the meeting point of said surface (2) to be doctored and the doctoring element (3) prior to the start of coating mix application, and
the application of the cooling fluid is cut off as soon as the application of the coating mix is commenced.

2. The method according to claim 1, characterized in that the cooling fluid is a flowable substance, advantageously water.

3. The method according to claim 1, characterized in that the cooling fluid is applied to the surface of the web (2) prior to the start of doctoring.

4. The method according to claim 1, 2 or 3, characterized in that the cooling fluid applied to the surface of the web (2) or the roll of said film-transfer press by an

9. The coater according to claim 5, characterized in that the web speed of said coater is greater than 1500 m/min.

10. The coater according to claim 5, characterized in that said coater is an on-machine coater.
